(19) United States
(12) Patent Application Publication
(10) Pub. No.: US 2023/0090678 A1
(43) Pub. Date: Mar. 23, 2023

(54) Magnetic Induction Heating System for a Railroad Switch Crib

(71) Applicant: Randall Graham, Jacksonville, FL (US)

(72) Inventor: Randall Graham, Jacksonville, FL (US)

(21) Appl. No.: 17/949,129

(22) Filed: Sep. 20, 2022

Related U.S. Application Data
(60) Provisional application No. 63/246,296, filed on Sep. 20, 2021.

(51) Int. Cl. E01B 19/00; H05B 6/10; H05B 6/44; H05B 6/04

(52) U.S. Cl. CPC E01B 19/00; H05B 6/10; H05B 6/44; H05B 6/04; H05B 2214/02

(57) ABSTRACT

A magnetic induction heating system for a railroad switch crib is a system that prevents the accumulation of ice or snow on or around the railroad switch crib area which can cause malfunction of the railroad switch components. To do so, the system includes at least one coil assembly that can be mounted under the railroad crib space between adjacent ties. The at least one coil assembly is designed to generate an oscillating electromagnetic field that agitates the atoms of the different metal components of the railroad crib space so that the metal components radiate enough heat that melts any accumulated ice or snow around the components. The at least one coil assembly can also be used to heat the railroad switch drive motor assembly by placing the at least one coil assembly under the motor drive unit to keep the unit free of ice or snow accumulation.

The current application claims a priority to the U.S. provisional patent application Ser. No. 63/246,296 filed on Sep. 20, 2021.

### FIELD OF THE INVENTION

The present invention generally relates to mechanisms for heating the railroad switch crib area to remove ice and/or snow in cold weather conditions. More specifically, the present invention relates to an apparatus for heating the cavity between the railroad ties where linkage rods must pass freely to operate the switch points on the above heated fixed rails.

### BACKGROUND OF THE INVENTION

In cold climate regions which frequently experience temperatures below freezing, the malfunction of railroad track switches is a common problem. Malfunction of the track switch can cause trains or vehicles moving over the track switch to derail, which can result in severe property damage and personal injuries. This issue is compounded by frequent precipitation in the form of snow or freezing rain. Temperatures below freezing and accumulations of snow or ice result in malfunction of railroad switches for several reasons. For example, snow accumulated between a fixed rail and an adjacent movable rail of a switch can pack and prevent proper engagement of the two rails. In addition, ice formed about or on the point of the movable rail, or between the movable rail and the fixed rail, may prevent proper engagement or separation of the two rails when required for switching the train or vehicle from one track to another. Further, the crib spaces between adjacent ties of the railroad switch which accommodate different rod(s) interconnecting the movable rails are also susceptible to accumulations of snow or ice that can interfere with the proper operation of the switch. Furthermore, even when the fixed rails in the switch area are heated suitably, a gauge plate joining the fixed rails on a track tie at the location of the switch rail can become a source of switch malfunction by dissipating so much heat that ice forms on the gauge plate and prevents displacement of the switch points.

To alleviate this issue, various solutions have been implemented such as heating the railroad rail switch. The heating of a rail switch to prevent failure or unreliability of the switch operation under cold weather conditions also involves a variety of problems and needs. For example, the heating mechanism to be employed must serve reliably to keep the switch clear of ice and snow, with safety and efficiency in its operation, economy in the production and installation of its component parts, and assurance that failures of operation due to burn-out or other cause will not occur over long periods of service. In addition, the heating mechanism must be safe to be installed by railroad workmen, to prompt repair at the switch location in the event of damage by accident or otherwise, and to accommodate fast removal and replacement whenever needed to enable repair or replacement of the rails, ties, or other structures at the rail switch. Furthermore, there are several types of switch heater systems on the market that use gas/hot air or electric resistive heating rods to melt snow. However, these systems generally waste large amounts of energy due to the inefficiencies of heat transfer from an outside heat source into the steel or area to be heated.

Therefore, an objective of the present invention is to provide a new and improved system for heating components of a railroad switch in a reliable, safe, efficient, and economical manner. The system of the present invention utilizes magnetic induction to heat the different metallic components of the railroad switch to prevent ice or snow accumulation on or around the railroad switch. Another objective of the present invention is to provide a magnetic induction heating system that can heat the cavity between the railroad ties where linkage rods must pass freely to operate the switch points on the above heated fixed rails. Additional features and benefits of the present invention are further discussed below.

### SUMMARY OF THE INVENTION

The present invention provides a magnetic induction heating system for a railroad switch crib. The present invention enables the steel components of the railroad switch crib to be heated to become the heat source themselves as the atoms within the core of the steel are agitated due to an oscillated magnetic field. The agitation of the steel atoms produces the heat needed to melt the surrounding ice and/or snow. Thus, no external heat source is needed. Having no external heat sources reduces heat losses due to heat transfer. Instead, the present invention offers electrical energy savings up to 80% of that of conventional crib heaters while producing superior performance.

### BRIEF DESCRIPTIONS OF THE DRAWINGS

FIG. 1 is a top perspective view of the coil assembly of the present invention.

FIG. 2 is a front view of the coil assembly of the present invention.

FIG. 3 is a top view of the coil assembly of the present invention.

FIG. 4 is a cross-sectional view taken in the direction of the line 4-4 in FIG. 3.

FIG. 5 is a top exploded perspective view of the coil assembly of the present invention.

FIG. 6 is a top perspective view of the coil assembly of the present invention, wherein the coil assembly is shown mounted under a mounting bracket.

FIG. 7 is a front view of the coil assembly of the present invention, wherein the coil assembly is shown mounted under the mounting bracket.

FIG. 8 is a top view of the coil assembly of the present invention, wherein the coil assembly is shown mounted under the mounting bracket.

FIG. 9 is a cross-sectional view taken in the direction of the line 9-9 in FIG. 8.

FIG. 10 is a front view of the coil assembly of the present invention, wherein the coil assembly is shown mounted under a switch drive motor assembly.

FIG. 11 is a schematic view showing the electrical connections and the electromagnetic connections of the present invention, wherein the electrical connections are shown in solid lines, and wherein the electromagnetic connections are shown in dotted lines.

### DETAIL DESCRIPTIONS OF THE INVENTION

All illustrations of the drawings are for the purpose of describing selected versions of the present invention and are not intended to limit the scope of the present invention.

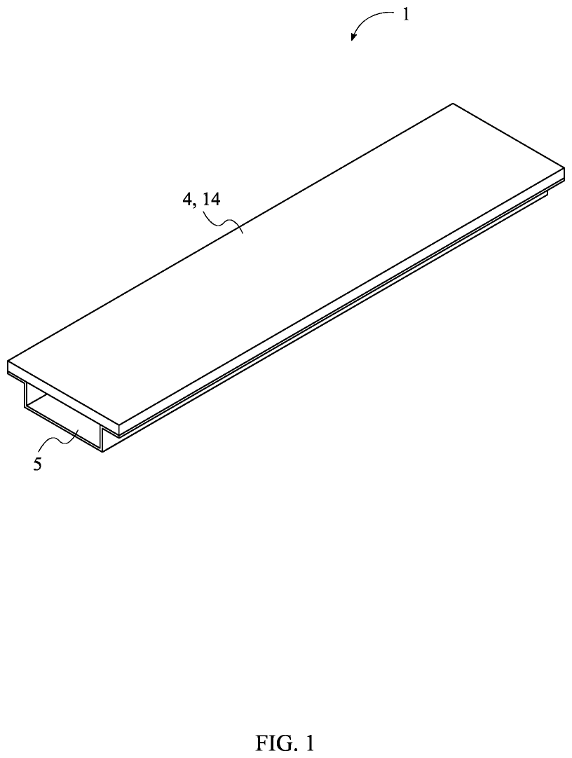

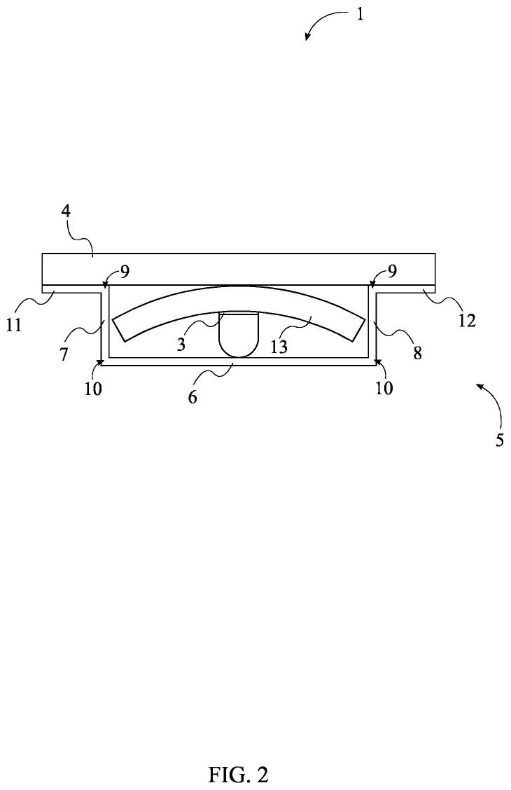

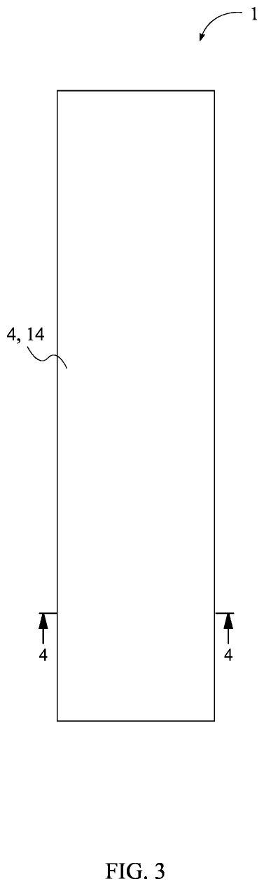

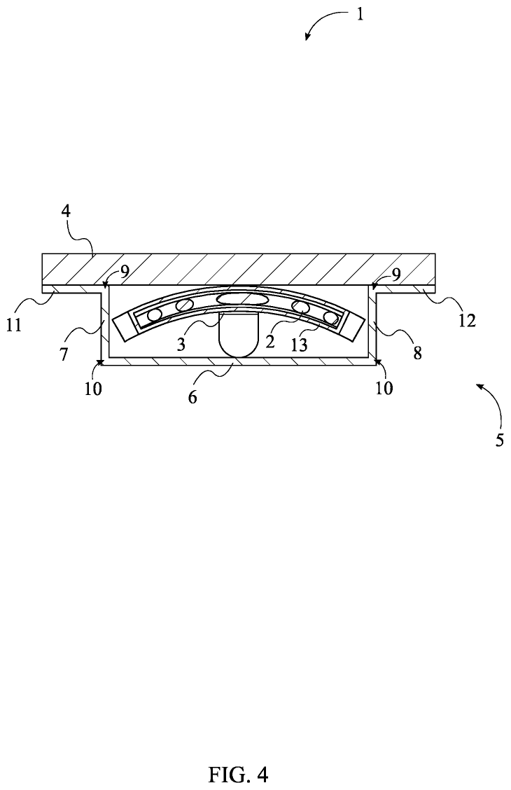

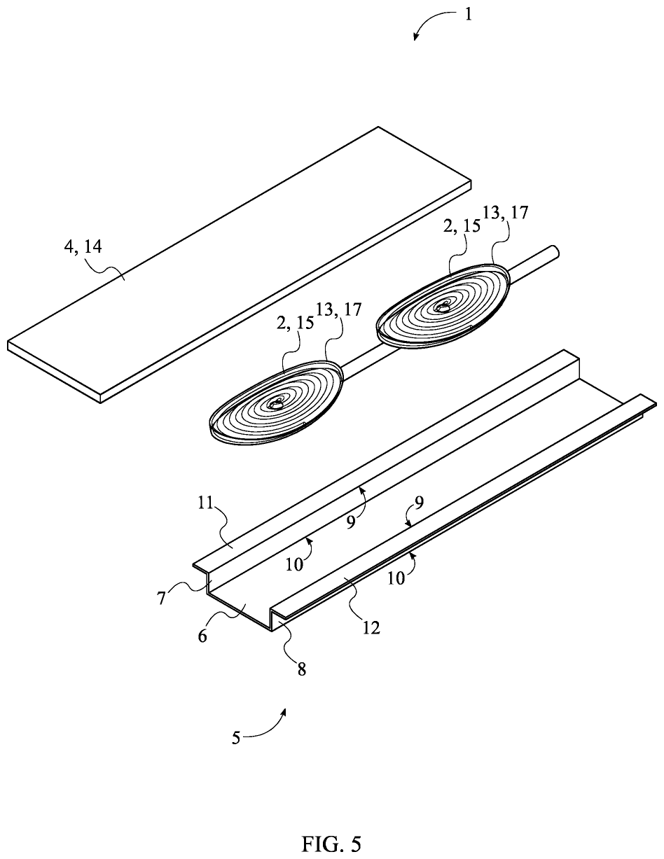

The present invention is a magnetic induction heating system for a railroad switch crib that prevents the accumulation of ice or snow on or around the railroad switch crib area that can cause malfunctions of the railroad switch. As can be seen in FIGS. 1 through 5, the present invention comprises at least one coil assembly 1 that can be mounted under the railroad crib space between adjacent ties. The at least one coil assembly 1 is designed to generate an oscillating electromagnetic (EM) field that agitates the atoms of the metal components of the railroad crib space so that the metal components serve radiate heat that melts any accumulated ice or snow in the surroundings. The at least one coil assembly 1 can also be used to heat the railroad switch drive motor by placing the at least one coil assembly 1 under the motor drive unit to keep the unit free of ice or snow.

The general configuration of the present invention allows for the heating of the railroad switch crib area to prevent malfunction of the railroad switch. The at least one coil assembly 1 is designed to be safely installed by the staff as well as to be safely and properly maintained as necessary. As can be seen in FIGS. 1 through 5, the at least one coil assembly 1 comprises at least one induction coil 2, a power supply terminal 3, at least one steel metal plate 4, and a coil box 5. The at least one induction coil 2 serves to generate an oscillating EM field that energizes the atoms on the metal components of the railroad switch. The power supply terminal 3 enables the electrical connection of the at least one induction coil 2 to a power supply for the operation of the at least one induction coil 2. The at least one steel metal plate 4 serves as the heat source to maintain the railroad switch crib area free from ice and/or snow accumulation. The coil box 5 keeps the at least one induction coil 2 close to the at least one steel metal plate 4.

As can be seen in FIGS. 1 through 5 and 11, to assemble the at least one coil assembly 1, the coil box 5 is mounted onto the at least one steel metal plate 4 to secure the coil box 5 to the at least one steel metal plate 4. The at least one induction coil 2 is positioned adjacent to the at least one steel metal plate 4 so that the generated EM field is oriented towards the at least one steel metal plate 4. Further, the power supply terminal 3 is positioned adjacent to the at least one induction coil 2 to maintain the power supply terminal 3 close to the at least one induction coil 2. In addition, the at least one induction coil 2 and the power supply terminal 3 are mounted within the coil box 5 to keep the at least one induction coil 2 and the power supply terminal 3 off the ground. The at least one induction coil 2 is also in electromagnetic communication with the ferrous metal plate due to the EM field generated by the at least one induction coil 2. Furthermore, the at least one induction coil 2 is electrically connected to the power supply terminal 3. This way, the at least one coil assembly 1 can be safely and correctly installed on the critical areas that require to be ice/snow free.

To ensure that the present invention can generate the EM field necessary to energize the metal components to cause the metal components to heat up, the present invention needs to span the length of the crib area. As can be seen in FIGS. 1 through 5, the at least one steel metal plate 4 is provided as an elongated plate body 14 with an overall length that spans the length of the crib area. Further, to ensure that the EM field generated covers the length of the at least one steel metal plate 4, the at least one induction coil 2 can be provided as a plurality of induction coils 15. In addition, to generate an EM field wide enough to cover the length of the at least one steel metal plate 4, the plurality of induction coils 15 is serially distributed along the elongated plate body 14. This way, the at least one coil assembly 1 can sufficiently energize the metal components to heat said components in order to prevent ice/snow accumulation in the surroundings.

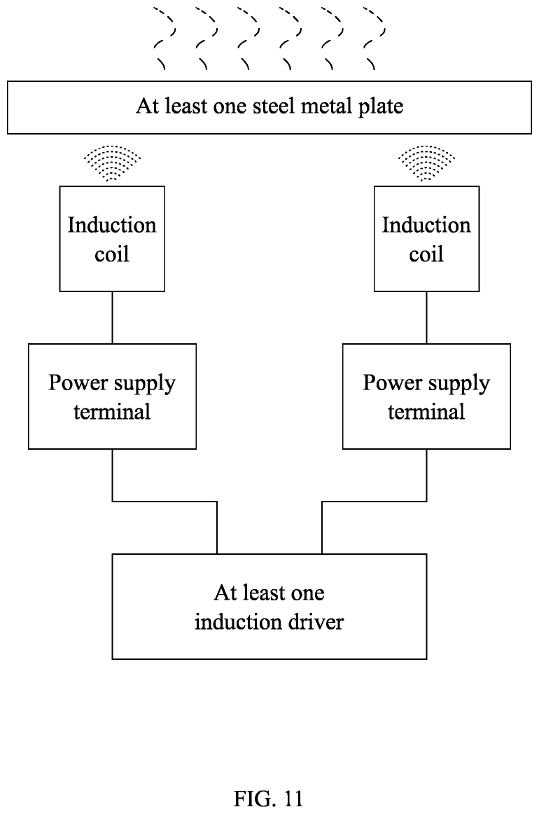

As previously mentioned, the present invention generates an oscillating EM field in order to energize the metal components of the railroad switch crib. As can be seen in FIG. 11, to control the generation and oscillation of the EM field, the present invention may further comprise at least one induction driver 16. The at least one induction driver 16 enables the automatic operation of the present invention by monitoring the weather conditions of the surroundings and engaging the at least one induction coil 2 as necessary. To do so, the at least one induction driver 16 is positioned offset to the at least one coil assembly 1 to monitor the weather conditions surrounding the railroad switch crib. Further, the at least one induction coil 2 is electrically connected to the at least one driver through the power supply terminal 3 to control the generation of the EM fields that energize the metal plates. This way, when the at least one induction driver 16 detects a weather condition that can result in heavy precipitation and accumulation of ice/snow, the at least one induction driver 16 powers the at least one induction coil 2 to generate an EM field to energize the metal components of the switch crib so that the metal components heat up. The at least one induction driver 16 also controls the oscillation of the EM field to ensure that the metal components reach a certain temperature to prevent ice/snow accumulation in the surroundings.

As can be seen in FIGS. 1 through 5, to further protect the at least one induction coil 2, the at least one coil assembly 1 may further comprise at least one coil enclosure 13 that houses the at least one induction coil 2. The at least one coil enclosure 13 also positions and shapes the at least one induction coil 2 to ensure that the generated EM field energizes a wide area of the metal components of the switch crib. To do so, the at least one induction coil 2 is mounted within the at least one coil enclosure 13. In addition, the coil enclosure is positioned adjacent to the at least one steel metal plate 4 in order to position the at least one induction coil 2 close to the at least one steel metal plate 4. Further, the at least one coil enclosure 13 is mounted within the coil box 5 to maintain the at least one induction coil 2 within the coil box 5.

In embodiments where there are multiple induction coils spread throughout the at least one steel metal plate 4, the at least one coil enclosure 13 may be provided as a plurality of coil enclosures 17. As can be seen in FIGS. 1 through 5, the at least one induction coil 2 is provided as a plurality of induction coils 15. To accommodate the several induction coils, each of the plurality of induction coils 15 is positioned within a corresponding enclosure of the plurality of coil enclosures 17. In addition, the plurality of coil enclosures 17 is distributed across the at least one steel metal plate 4. This way, the induction coils and the corresponding coil enclosures are distributed along the at least one steel metal plate 4 to ensure the EM field energizes the whole metal plate.

The coil box 5 is designed to ensure that the at least one induction coil 2 is positioned adjacent to the at least one steel metal plate 4 while also protecting the at least one induction coil 2 from the surroundings. As can be seen in FIGS. 1 through 5, the coil box 5 may comprise a box floor 6, a first lateral wall 7, and a second lateral wall 8. The box floor 6, the first lateral wall 7, and the second lateral wall 8 are arranged to form a box structure that surrounds the at least one induction coil 2 and keeps the at least one induction coil 2 adjacent to the at least one steel metal plate 4. The first lateral wall 7 and the second lateral wall 8 are preferably elongated thin plates of similar size. Accordingly, the first lateral wall 7 and the second lateral wall 8 each comprises a proximal lengthwise edge 9 and a distal lengthwise edge 10 that correspond to the two longest edges of each lateral wall. To form the coil box 5, the first lateral wall 7 and the second lateral wall 8 are positioned parallel to each other. In addition, the first lateral wall 7 and the second lateral wall 8 are also positioned perpendicular to the box floor 6 to shape the coil box 5 as a rectangular structure. Further, the distal lengthwise edge 10 of the first lateral wall 7 is connected adjacent to the box floor 6 to secure the first lateral wall 7 to the box floor 6. Similarly, the distal lengthwise edge 10 of the second lateral wall 8 is connected adjacent to the box floor 6, opposite to the first lateral wall 7, to secure the second lateral wall 8 to the box floor 6. Furthermore, the proximal lengthwise edge 9 of the first lateral wall 7 and the proximal lengthwise edge 9 of the second lateral wall 8 are attached across the at least one steel metal plate 4 to secure the box floor 6 to the at least one steel metal plate 4. This way, the at least one induction coil 2 can rest on the box floor 6 while being protected from the surroundings.

Connecting the first lateral wall 7 and the second lateral wall 8 to the at least one steel metal plate 4 can be difficult and not secure enough to protect the at least one induction coil 2. So, the coil box 5 may further comprise a first wall ledge 11 and a second wall ledge 12 that securely connect the first lateral wall 7 and the second lateral wall 8 to the at least one steel metal plate 4, respectively. As can be seen in FIG. 1 through 5, the first wall ledge 11 is positioned perpendicular to the first lateral wall 7. The first wall ledge 11 is also connected along the proximal lengthwise edge 9 of the first lateral wall 7. In addition, the first wall ledge 11 is oriented away from the second lateral wall 8. This way, the first wall ledge 11 forms an L-shaped structure with the first lateral wall 7 with the first wall ledge 11 being positioned against the at least one steel metal plate 4. Likewise, the second wall ledge 12 is positioned perpendicular to the second lateral wall 8. The second wall ledge 12 is also connected along the proximal lengthwise edge 9 of the second lateral wall 8. In addition, the second wall ledge 12 is oriented away from the first lateral wall 7. This way, the second wall ledge 12 also forms an L-shaped structure with the second lateral wall 8 with the second wall ledge 12 being positioned against the at least one steel metal plate 4. Further, the first wall ledge 11 and the second wall ledge 12 are attached onto the at least one steel metal plate 4. Thus, the coil box 5 is securely connected to the at least one steel metal plate 4 to retain the at least one induction coil 2 in the correct position against the at least one steel metal plate 4.

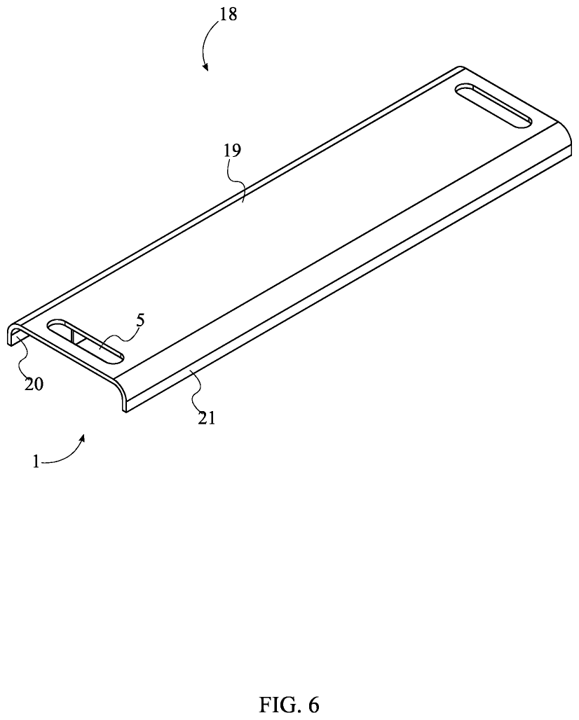

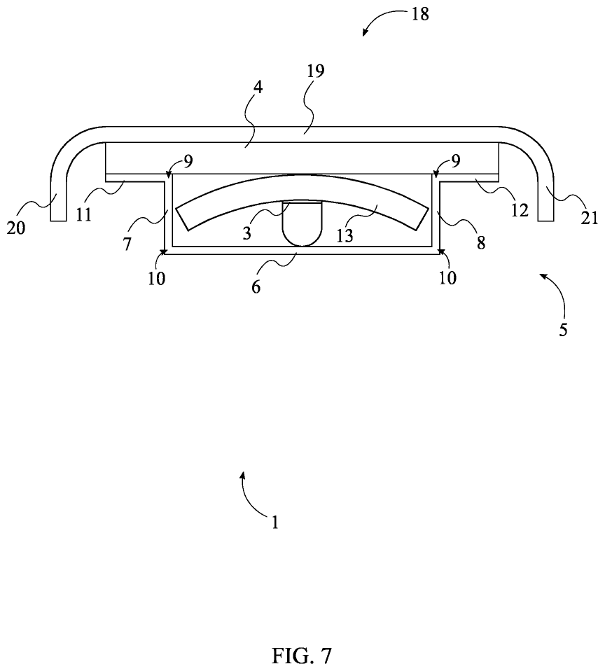

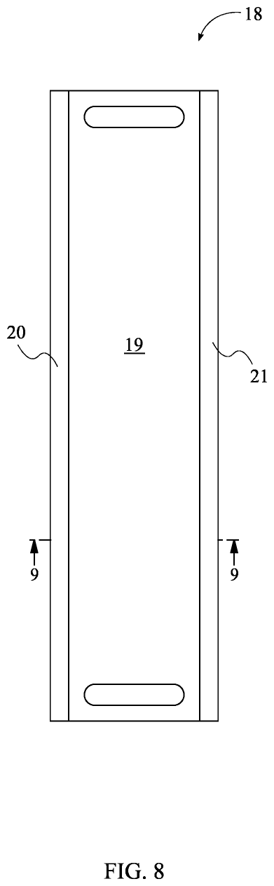

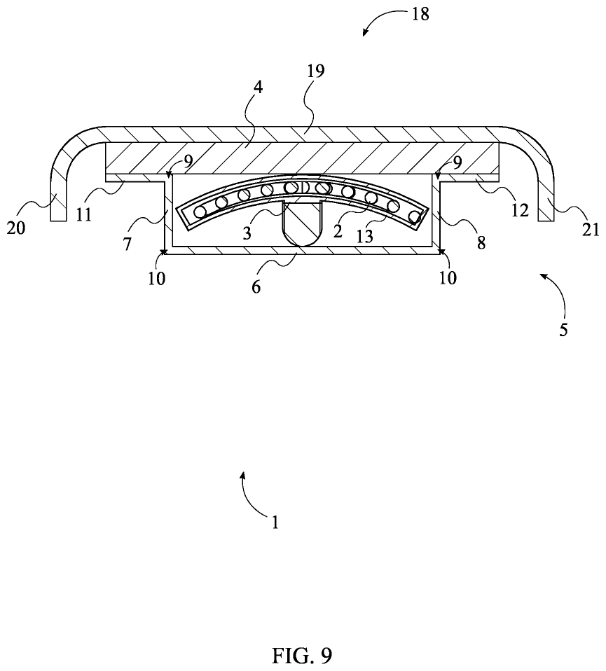

As previously discussed, the present invention can be arranged to heat the railroad crib space between adjacent ties. As can be seen in FIGS. 6 through 9, the present invention may further comprise a mounting bracket 18 that conducts the heat generated by the at least one steel metal plate 4 to other metal components of the railroad switch crib area. The mounting bracket 18 comprises a central bracket plate 19, a first bracket flange 20, and a second bracket flange 21. The central bracket plate 19 receives the at least one coil assembly 1. The first bracket flange 20 and the second bracket flange 21 secure the central bracket plate 19 and the at least one coil assembly 1 to the adjacent railroad ties. To do so, the first bracket flange 20 and the second bracket flange 21 are positioned parallel to each other. In addition, the first bracket flange 20 and the second bracket flange 21 are positioned perpendicular to the central bracket plate 19. This forms an overall C-shaped bracket structure. Further, the first bracket flange 20 is connected adjacent to the central bracket plate 19 to secure the first bracket flange 20 to the central bracket plate 19. Similarly, the second bracket flange 21 is connected adjacent to the central bracket plate 19, opposite to the first bracket flange 20, to secure the second bracket flange 21 to the central bracket plate 19. Further, the at least one coil assembly 1 is positioned in between the first bracket flange 20 and the second bracket flange 21. The at least one steel metal plate 4 and the coil box 5 are also attached onto the central bracket plate 19. This way, the at least one steel metal plate 4 is positioned against the central bracket plate 19. So, when the at least one induction coil 2 is engaged to generate an EM field, the EM field reaches the at least one steel metal plate 4 to energize the at least one steel metal plate 4 which causes the at least one steel metal plate 4 to heat up. As the at least one steel metal plate 4 heats up, the central bracket plate 19 also heats up and conducts the heat to adjacent metal components of the railroad switch crib to prevent ice/snow accumulation.

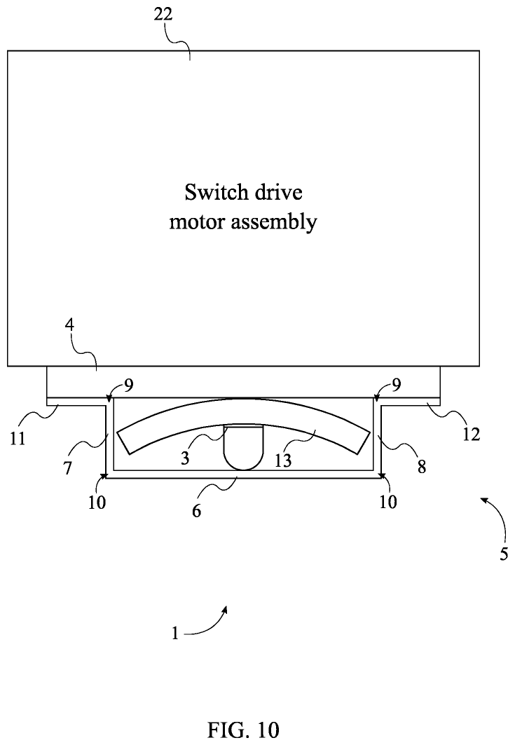

As previously discussed, the present invention can also be used to heat the railroad switch drive motor assembly 22. As can be seen in FIG. 10, the present invention may further comprise a switch drive motor assembly 22 that drives the railroad switch. The switch drive motor assembly 22 is mounted adjacent to the at least one steel metal plate 4, opposite to the at least one coil box 5, so that as the at least one steel metal plate 4 heats up, the switch drive motor assembly 22 also heats up to prevent ice/snow accumulation around the switch drive motor assembly 22. In other embodiments, the present invention can be arranged to be installed adjacent to other metal components of the railroad switch crib area to prevent ice/snow accumulation around those desired metal components.

Although the invention has been explained in relation to its preferred embodiment, it is to be understood that many other possible modifications and variations can be made without departing from the spirit and scope of the invention.

What is claimed is:

1. A magnetic induction heating system for a railroad switch crib comprising:
at least one coil assembly;
the at least one coil assembly comprising at least one induction coil, a power supply terminal, at least one steel metal plate, and a coil box;
the coil box being mounted onto the at least one steel metal plate;
the at least one induction coil being positioned adjacent to the at least one steel metal plate;
the power supply terminal being positioned adjacent to the at least one induction coil;
the at least one induction coil and the power supply terminal being mounted within the coil box;
the at least one induction coil being in electromagnetic communication with the ferrous metal plate; and
the at least one induction coil being electrically connected to the power supply terminal.

2. The magnetic induction heating system for a railroad switch crib as claimed in claim 1 comprising:
the at least one steel metal plate being an elongated plate body;
the at least one induction coil being a plurality of induction coils; and
the plurality of induction coils being serially distributed along the elongated plate body.

3. The magnetic induction heating system for a railroad switch crib as claimed in claim 1 comprising:
at least one induction driver;
the at least one induction driver being positioned offset to the at least one coil assembly; and
the at least one induction coil being electrically connected to the at least one driver through the power supply terminal.

4. The magnetic induction heating system for a railroad switch crib as claimed in claim 1 comprising:
the at least one coil assembly further comprising at least one coil enclosure;
the at least one induction coil being mounted within the at least one coil enclosure;
the at least one coil enclosure being positioned adjacent to the at least one steel metal plate; and
the at least one coil enclosure being mounted within the coil box.

5. The magnetic induction heating system for a railroad switch crib as claimed in claim 4 comprising:
the at least one coil enclosure being a plurality of coil enclosures;
the at least one induction coil being a plurality of induction coils;
each of the plurality of induction coils being positioned within a corresponding enclosure of the plurality of coil enclosures; and
the plurality of coil enclosures being distributed across the at least one steel metal plate.

6. The magnetic induction heating system for a railroad switch crib as claimed in claim 1 comprising:
the coil box comprising a box floor, a first lateral wall, and a second lateral wall;
the first lateral wall and the second lateral wall each comprising a proximal lengthwise edge and a distal lengthwise edge;
the first lateral wall and the second lateral wall being positioned parallel to each other;
the first lateral wall and the second lateral wall being positioned perpendicular to the box floor;
the distal lengthwise edge of the first lateral wall being connected adjacent to the box floor;
the distal lengthwise edge of the second lateral wall being connected adjacent to the box floor, opposite to the first lateral wall; and
the proximal lengthwise edge of the first lateral wall and the proximal lengthwise edge of the second lateral wall being attached across the at least one steel metal plate.

7. The magnetic induction heating system for a railroad switch crib as claimed in claim 6 comprising:
the coil box further comprising a first wall ledge and a second wall ledge;
the first wall ledge being positioned perpendicular to the first lateral wall;
the first wall ledge being connected along the proximal lengthwise edge of the first lateral wall;
the first wall ledge being oriented away from the second lateral wall;
the second wall ledge being positioned perpendicular to the second lateral wall;
the second wall ledge being connected along the proximal lengthwise edge of the second lateral wall;
the second wall ledge being oriented away from the first lateral wall; and
the first wall ledge and the second wall ledge being attached onto the at least one steel metal plate.

8. The magnetic induction heating system for a railroad switch crib as claimed in claim 1 comprising:
a mounting bracket;
the mounting bracket comprising a central bracket plate, a first bracket flange, and a second bracket flange;
the first bracket flange and the second bracket flange being positioned parallel to each other;
the first bracket flange and the second bracket flange being positioned perpendicular to the central bracket plate;
the first bracket flange being connected adjacent to the central bracket plate;
the second bracket flange being connected adjacent to the central bracket plate, opposite to the first bracket flange;
the at least one coil assembly being positioned in between the first bracket flange and the second bracket flange; and
the at least one steel metal plate and the coil box being attached onto the central bracket plate.

9. The magnetic induction heating system for a railroad switch crib as claimed in claim 1 comprising:
a switch drive motor assembly; and
the switch drive motor assembly being mounted adjacent to the at least one steel metal plate, opposite to the at least one coil box.

10. A magnetic induction heating system for a railroad switch crib comprising:
at least one coil assembly;
the at least one coil assembly comprising at least one induction coil, a power supply terminal, at least one steel metal plate, a coil box, and at least one coil enclosure;
the at least one coil enclosure being mounted within the coil box;
the coil box being mounted onto the at least one steel metal plate;
the at least one induction coil being mounted within the at least one coil enclosure;
the at least one coil enclosure being positioned adjacent to the at least one steel metal plate;
the power supply terminal being positioned adjacent to the at least one induction coil;
the at least one induction coil and the power supply terminal being mounted within the coil box;
the at least one induction coil being in electromagnetic communication with the ferrous metal plate; and
the at least one induction coil being electrically connected to the power supply terminal.

11. The magnetic induction heating system for a railroad switch crib as claimed in claim 10 comprising:
the at least one steel metal plate being an elongated plate body;
the at least one induction coil being a plurality of induction coils; and
the plurality of induction coils being serially distributed along the elongated plate body.

12. The magnetic induction heating system for a railroad switch crib as claimed in claim 10 comprising:
at least one induction driver;
the at least one induction driver being positioned offset to the at least one coil assembly; and
the at least one induction coil being electrically connected to the at least one driver through the power supply terminal.

13. The magnetic induction heating system for a railroad switch crib as claimed in claim 10 comprising:
the at least one coil enclosure being a plurality of coil enclosures;
the at least one induction coil being a plurality of induction coils;
each of the plurality of induction coils being positioned within a corresponding enclosure of the plurality of coil enclosures; and
the plurality of coil enclosures being distributed across the at least one steel metal plate.

14. The magnetic induction heating system for a railroad switch crib as claimed in claim 10 comprising:
the coil box comprising a box floor, a first lateral wall, and a second lateral wall;
the first lateral wall and the second lateral wall each comprising a proximal lengthwise edge and a distal lengthwise edge;
the first lateral wall and the second lateral wall being positioned parallel to each other;
the first lateral wall and the second lateral wall being positioned perpendicular to the box floor;
the distal lengthwise edge of the first lateral wall being connected adjacent to the box floor;
the distal lengthwise edge of the second lateral wall being connected adjacent to the box floor, opposite to the first lateral wall; and
the proximal lengthwise edge of the first lateral wall and the proximal lengthwise edge of the second lateral wall being attached across the at least one steel metal plate.

15. The magnetic induction heating system for a railroad switch crib as claimed in claim 14 comprising:
the coil box further comprising a first wall ledge and a second wall ledge;
the first wall ledge being positioned perpendicular to the first lateral wall;
the first wall ledge being connected along the proximal lengthwise edge of the first lateral wall;
the first wall ledge being oriented away from the second lateral wall;
the second wall ledge being positioned perpendicular to the second lateral wall;
the second wall ledge being connected along the proximal lengthwise edge of the second lateral wall;
the second wall ledge being oriented away from the first lateral wall; and
the first wall ledge and the second wall ledge being attached onto the at least one steel metal plate.

16. The magnetic induction heating system for a railroad switch crib as claimed in claim 10 comprising:
a mounting bracket;
the mounting bracket comprising a central bracket plate, a first bracket flange, and a second bracket flange;
the first bracket flange and the second bracket flange being positioned parallel to each other;
the first bracket flange and the second bracket flange being positioned perpendicular to the central bracket plate;
the first bracket flange being connected adjacent to the central bracket plate;
the second bracket flange being connected adjacent to the central bracket plate, opposite to the first bracket flange;
the at least one coil assembly being positioned in between the first bracket flange and the second bracket flange; and
the at least one steel metal plate and the coil box being attached onto the central bracket plate.

17. The magnetic induction heating system for a railroad switch crib as claimed in claim 10 comprising:
a switch drive motor assembly; and
the switch drive motor assembly being mounted adjacent to the at least one steel metal plate, opposite to the at least one coil box.
